(19) United States
(12) Patent Application Publication
(10) Pub. No.: US 2010/0277279 A1
(43) Pub. Date: Nov. 4, 2010

(54) RFID PRIVACY PROTECTION METHOD AND APPARATUS

(75) Inventors: Ho Won Kim, Daejeon (KR); Kyo II Chung, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/747,875

(22) PCT Filed: Dec. 10, 2008
(86) PCT No.: PCT/KR08/07308

§ 371 Date: Jun. 11, 2010

(30) Foreign Application Priority Data
Dec. 11, 2007 (KR) 10-207-0128193

(51) Int. Cl. G06F 7/04

(52) U.S. Cl. 340/5.85

(57) ABSTRACT

A Radio Frequency Identification (RFID) privacy protection method and apparatus is provided. The RFID privacy protection method includes: receiving a password of a tag; reading a code value from the tag; performing authentication of a user with respect to the tag using the code value and the password; and deactivating the tag electrically or physically based on a result of the performing.

### TECHNICAL FIELD

The present invention relates to a Radio Frequency Identification (RFID) privacy protection method and an RFID privacy protection apparatus.

This work was supported by the IT R&D program of MIC/IITA [2005-S-088-03, Development of security technology for secure RFID/USN service].

### Background Art

Radio Frequency Identification (RFID) technology is a technology of providing product consumers and enterprisers with various services including verifying a distribution channel of a product, verifying whether the product is genuine, acquiring information about the product, providing an additional after-sales service, and the like by interoperating information of a tag with various information existing in a server, the tag being attached to the product or being inherent in the product. The various services based on the RFID technology provide the product consumers with convenience and security, and enable the enterprisers to promote efficiency of enterprises and to increase profits.

However, a possibility of security vulnerabilities and of invasion of privacy are basically inherent in the RFID technology since an RFID tag basically performs communication between a tag and a reader using electrical field combination, magnetic field combination, Radio Frequency (RF) communication, a wireless frequency, and the like, and an Electronic Product Code (EPC) tag (or a tag of an International Standardization Organization (ISO) 18000-6 series) in a Ultra High Frequency (UHF) bandwidth currently widely used for a circulation/physical distribution on the market excludes an authentication function with respect to the tag and an access control function.

Conventional arts for preventing the security vulnerability and privacy intrusion are described below. A scheme of performing authentication with respect to a reader using either a hash function such as hash lock for the RFID tag or a symmetric key encryption scheme exists. This enables an illicit reader not to decrypt a hash-encrypted or symmetric key-encrypted value even when a value of the tag is read. However, since an air interface protocol between the legacy tag and the reader needs to be changed in order to apply this scheme to the current UHF RFID tag, and a hash or symmetric key encryption algorithm needs to be embodied in the tag in hardware, this scheme may not be applied to a legacy passive-type tag.

A technology of adjusting an antenna length of the tag in order to protect privacy of a consumer carrying the product to which the tag is attached exists as another privacy protection technology of the RFID technology. When RFID enterprisers use the RFID tag for a purpose of distribution channel verification and the like, the RFID tag may be recognized in a distance of several meters using a long antenna of the RFID tag, however, when the product to which the tag is attached is sold to the general consumers, a long recognition distance is unnecessary, and a length of a corresponding antenna is reduced in order to protect privacy of the consumers carrying the product to which the tag is attached. This scheme has an advantage of protecting privacy of the consumers carrying the product to which the RFID tag is attached by eliminating a need for deactivating the tag. However, since an illicit reader may read the tag from a short distance even when the recognition distance is adjusted by reducing the length of the antenna, privacy may not be sufficiently protected.

A technology of storing an encrypted (or signed) value in a user memory and using the encrypted (or signed) value as a code value of the RFID tag exists as still another privacy protection scheme. In this case, when a key value of decrypting encrypted data does not exist or the signed value may not be verified, a meaning of the corresponding value may not be known. Through this, privacy of a corresponding tag owner is protected. However, this scheme has a disadvantage that a specially-developed RFID backend system needs to be included in order to decrypt a signed or encrypted RFID tag code value, and efficiency of a corresponding system decreases as a number of RFID tags using the above-described scheme.

In addition to the above-described schemes, a scheme of enabling only a reader authenticated by a secure communication channel to access the RFID backend system, and to know a meaning of the read RFID code value exists. Even when an unauthorized person reads the RFID code value using his/her own reader, the person needs to access to a backend system server referred to either as an Object Information Sever (OIS) or an Electronic Product Code Information Service (EPCIS) in order to analyze the meaning of the code value. When an authority does not exist, the person may not access the RFID backend system. However, a person carrying the product including the RFID tag is still subject to a possibility of an invasion of privacy. Since an illicit reader may know the meaning of the code value using a database (DB) collected by itself even when a detailed meaning of a corresponding code may not be verified, or the illicit reader may be aware that the consumer carries the tag including the specific code value even when the illicit reader is unaware of the meaning of the code value, this causes invasion of privacy of the consumer.

In order to embody the above-described RFID security vulnerability solving scheme and the above-described privacy protection scheme, an appropriate embodiment needs to be performed to modify the tag or to apply the corresponding scheme to the RFID backend system. Since these schemes are different from the RFID tag distributed on the market or are different from a standard, many costs are incurred. These schemes may not completely solve a problem concerning invasion of privacy. Accordingly, a very simple scheme, “kill tag,” is disclosed in an EPC global standard and the like. This enables the privacy intrusion problem due to the RFID tag not to occur by permanently deactivating the RFID tag. This kill tag function is set as a standard in an EPC tag and a UHF RFID tag.

Accordingly, the present invention discloses a technology of efficiently performing privacy protection with respect to the RFID tag using the kill tag function. The present invention discloses a technology of efficiently performing privacy protection with respect to the RFID tag using a function of deactivating the RFID tag electrically or physically. The present invention discloses a technology of efficiently performing privacy protection with respect to the RFID tag using a function of personalizing the RFID tag.

### DISCLOSURE OF INVENTION

### Technical Problem

The present invention provides a Radio Frequency Identification (RFID) privacy protection apparatus which can prevent a problem of invasion of privacy resulting from RFID tag contents being read by a random RFID reader regardless of consumers' own intentions, the consumers purchasing a product to which an RFID tag is attached.

The present invention is not limited to the above-described purposes and other purposes not described herein will be apparent to those of skill in the art from the following description.

### Technical Solution

According to an aspect of the present invention, there is provided a Radio Frequency

Identification (RFID) privacy protection method, the method including: receiving a password of a tag; reading a code value from the tag; performing authentication of a user with respect to the tag using the code value and the password; and deactivating the tag electrically or physically based on a result of the performing.

In an aspect of the present invention, the deactivating includes: verifying a characteristic of the tag using the code value; and deactivating the tag electrically or physically based on the verified characteristic of the tag.

In an aspect of the present invention, the deactivating includes: either inducing either an electric field or a magnetic field, and burning a circuit of the tag; or inducing either the electric field or the magnetic field, and erasing either a register or a memory in the tag.

In an aspect of the present invention, the deactivating includes: verifying a characteristic of a product to which the tag is attached, using the code value; and electrically deactivating the tag based on the verified characteristic of the product.

In an aspect of the present invention, the deactivating includes: either physically destroying an antenna in the tag; or physically pulverizing a chip in the tag.

In an aspect of the present invention, the RFID privacy protection method further includes: repeating a deactivation operation during predetermined times when the deactivation operation with respect to the tag fails.

According to another aspect of the present invention, there is provided an RFID privacy protection method, the method including: detecting a code value from a tag; changing the detected code value and generating a personalization code value; and controlling access to the tag based on the generated personalization code value.

In an aspect of the present invention, the changing and generating includes any one of: receiving a second code value from a user, changing the code value into the received second code value, and generating the personalization code value; generating the second code value using a random number generator, changing the code value into the generated second code value, and generating the personalization code value; and generating the second code value using personal information of the user, the information existing in a mobile terminal of the user, changing the code value into the generated second code value, and generating the personalization code value.

In an aspect of the present invention, the RFID privacy protection method further includes: storing the generated personalization code value in storage media related to a user of the tag.

In an aspect of the present invention, the storing includes: storing the personalization code value in the storage media, the personalization code value corresponding to the code value, and the RFID privacy protection method further includes: restoring the code value corresponding to the personalization code value with reference to the storage media; and providing the user with information in the tag using the restored code value.

In an aspect of the present invention, the RFID privacy protection method further includes: providing the user with the personalization code value and the code value with reference to the storage media.

In an aspect of the present invention, the storing includes: storing the personalization code value and the code value in any one of a text form, a binary form, and an encrypted form.

According to still another aspect of the present invention, there is provided an RFID privacy protection apparatus, the apparatus including: a receiving unit to receive a password of a tag; a reader unit to read a code value from the tag; an authentication unit to perform authentication of a user with respect to the tag using the code value and the password; and a deactivation unit to deactivate the tag electrically or physically based on a result of the performing.

In an aspect of the present invention, the deactivation unit verifies a characteristic of the tag using the code value, and deactivates the tag electrically or physically based on the verified characteristic of the tag.

In an aspect of the present invention, the deactivation unit induces either an electric field or a magnetic field and burns a circuit of the tag, or induces either the electric field or the magnetic field and erases either a register or a memory in the tag.

In an aspect of the present invention, the deactivation unit verifies a characteristic of a product to which the tag is attached, using the code value, and electrically deactivates the tag based on the verified characteristic of the product.

In an aspect of the present invention, the deactivation unit physically destroys an antenna in the tag, or physically pulverizes a chip in the tag.

In an aspect of the present invention, the deactivation unit repeats a deactivation operation during predetermined times when the deactivation operation with respect to the tag fails.

According to yet another aspect of the present invention, there is provided an RFID privacy protection apparatus, the apparatus including: a detection unit to detect a code value from a tag; a generation unit to change the detected code value and to generate a personalization code value; and an authentication unit to control access to the tag based on the generated personalization code value.

In an aspect of the present invention, the generation unit receives a second code value from a user, changes the code value into the received second code value, and generates the personalization code value, or generates the second code value using a random number generator, changes the code value into the generated second code value, and generates the personalization code value, or generates the second code value using personal information of the user, the information existing in a mobile terminal of the user, changes the code value into the generated second code value, and generates the personalization code value.

In an aspect of the present invention, the RFID privacy protection apparatus further includes: a storage unit to store the generated personalization code value in storage media related to a user of the tag.

In an aspect of the present invention, the storage unit stores the personalization code value in the storage media, the personalization code value corresponding to the code value, and the RFID privacy protection apparatus further includes: a providing unit to restore the code value corresponding to the personalization code value with reference to the storage media, and to provide the user with information in the tag using the restored code value.

In an aspect of the present invention, the providing unit provides the user with the personalization code value and the code value with reference to the storage media.

In an aspect of the present invention, the storage unit stores the personalization code value and the code value in any one of a text form, a binary form, and an encrypted form.

Additional aspects, features, and/or advantages of the invention will be set forth in part in the description which follows and, in part, will be apparent from the description, or may be learned by practice of the invention.

### BRIEF DESCRIPTION OF THE DRAWINGS

FIG. 1 is a block diagram illustrating a Radio Frequency Identification (RFID) privacy protection apparatus according to an exemplary embodiment of the present invention;

FIG. 2 is a block diagram illustrating an RFID privacy protection apparatus according to another exemplary embodiment of the present invention;

FIG. 3 is a flowchart briefly illustrating an RFID privacy protection method according to exemplary embodiments of the present invention;

FIG. 4 is a flowchart illustrating an RFID privacy protection method according to an exemplary embodiment of the present invention;

FIG. 5 is a flowchart illustrating an RFID privacy protection method according to another exemplary embodiment of the present invention;

FIG. 6 is a flowchart illustrating an RFID privacy protection method according to still another exemplary embodiment of the present invention;

FIG. 7 is a flowchart illustrating an RFID privacy protection method according to yet another exemplary embodiment of the present invention; and

FIG. 8 is a flowchart illustrating a process of performing tag personalization and waiting for a result according to an exemplary embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

A Radio Frequency Identification (RFID) privacy protection apparatus according to an exemplary embodiment of the present invention includes a function of efficiently performing a kill tag function being provided by an Ultra High Frequency (UHF) RFID tag, electrically/physically deactivating an RFID tag, and personalizing a code value included in the RFID tag. The RFID privacy protection apparatus performs a function as a public reader to verify RFID code contents for individual consumers being unable to easily access an RFID reader. The RFID privacy protection apparatus may be installed in a large outlet, a market, a public place, and the like, and strengthen privacy of a consumer carrying a product to the RFID tag is attached.

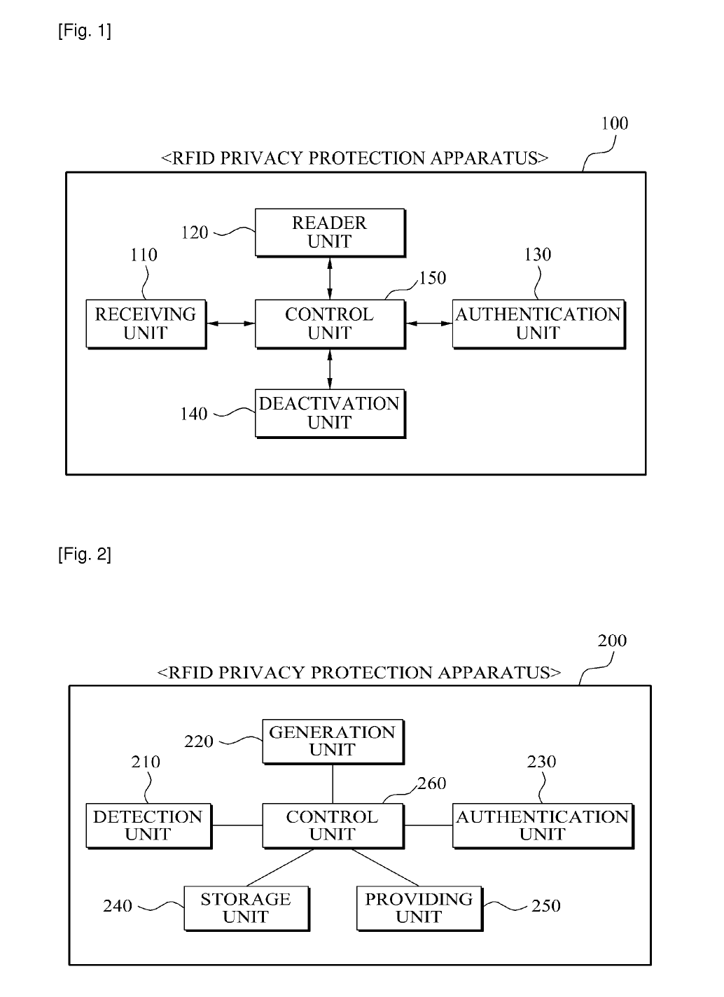

FIG. 1 is a block diagram illustrating an RFID privacy protection apparatus 100 according to an exemplary embodiment of the present invention.

Referring to FIG. 1, the RFID privacy protection apparatus 100 according to an exemplary embodiment of the present invention includes a receiving unit 110, a reader unit 120, an authentication unit 130, a deactivation unit 140, and a control unit 150.

The receiving unit 110 receives a password of a tag. The receiving unit 110 may receive the password of the tag from either a user or an RFID backend server (not shown). Here, the user may access the RFID backend server through an authentication process in order to receive the password of the tag from the RFID backend server, and receive the password of the tag.

The reader unit 120 reads a code value from the tag. The reader unit 120 may drive a predetermined decryption program and decrypt the read code value.

The authentication unit 130 performs authentication of the user with respect to the tag using the code value and the password. The authentication unit 130 compares the code value and the password, and performs the authentication of the user with respect to the tag based on a result of the comparing.

For example, when the code value and the password are same based on the result of the comparing, the authentication unit 130 may determine that the authentication of the user with respect to the tag succeeds. Conversely, when the code value and the password are different based on the result of the comparing, the authentication unit 130 may determine that the authentication of the user with respect to the tag fails.

The deactivation unit 140 deactivates the tag electrically or physically based on a result of the performing. When the authentication of the user with respect to the tag succeeds, the deactivation unit 140 deactivates the tag electrically or physically. Conversely, when the authentication of the user with respect to the tag fails, the deactivation unit 140 does not perform a deactivation operation with respect to the tag.

When the authentication of the user with respect to the tag succeeds, the deactivation unit 140 verifies a characteristic of the tag using the code value, and deactivates the tag electrically or physically based on the verified characteristic of the tag.

The deactivation unit 140 may electrically stop a function of the tag using a scheme of (1) inducing either an electric field or a magnetic field and burning a circuit of the tag, (2) inducing either the electric field or the magnetic field and erasing either a register or a memory in the tag, and the like as an electrical deactivation scheme.

Conversely, the deactivation unit 140 verifies a characteristic of a product to which the tag is attached, using the code value, and electrically deactivates the tag based on the verified characteristic of the product. For example, when the product includes a characteristic of being easily damaged by electricity, the deactivation unit 140 may not perform an electrical deactivation operation based on the characteristic of the product. The deactivation unit 140 may perform the electrical deactivation operation for only the tag attached to the product not being damaged by electrical deactivation.

The deactivation unit 140 may physically stop the function of the tag using a scheme of (1) physically destroying an antenna in the tag, (2) physically pulverizing a chip in the tag, and the like as a physical deactivation scheme.

The deactivation unit 140 repeats a deactivation operation during predetermined times when the deactivation operation with respect to the tag fails.

The control unit 150 generally controls the RFID privacy protection apparatus 100 according to an exemplary embodiment of the present invention. The control unit 150 may control operations of the receiving unit 110, the reader unit 120, the authentication unit 130, the deactivation unit 140, and the like.

FIG. 2 is a block diagram illustrating an RFID privacy protection apparatus 200 according to another exemplary embodiment of the present invention.

Referring to FIG. 2, the RFID privacy protection apparatus 200 according to another exemplary embodiment of the present invention includes a detection unit 210, a generation unit 220, an authentication unit 230, a storage unit 240, a providing unit 250, and a control unit 260.

The detection unit 210 detects a code value from a tag. The code value is stored in a memory in the tag. Accordingly, the detection unit 210 may access the memory in the tag and detect the code value.

The generation unit 220 changes the detected code value and generates a personalization code value. The generation unit 220 receives a second code value from a user, changes the code value into the received second code value, and generates the personalization code value. Alternatively, the generation unit 220 generates the second code value using a random number generator, changes the code value into the generated second code value, and generates the personalization code value. Alternatively, the generation unit 220 generates the second code value using personal information of the user, the information existing in a mobile terminal of the user, changes the code value into the generated second code value, and generates the personalization code value.

The authentication unit 230 controls access to the tag based on the generated personalization code value. When the generated personalization code value is received from the user, the authentication unit 230 permits the access to the tag. Conversely, when the generated personalization code value is not received from the user, the authentication unit 230 prohibits the access to the tag.

For example, when the generated personalization code value corresponds to ‘12345 ’ and ‘12345 ’ is received from the user, the authentication unit 230 may permit the access to the tag. Conversely, when a value other than ‘12345’ is received from the user, the authentication unit 230 may prohibit the access to the tag.

The storage unit 240 stores the generated personalization code value in storage media related to the user of the tag. The storage unit 240 stores the personalization code value in the storage media, the personalization code value corresponding to the code value. The storage unit 240 stores the personalization code value and the code value in a text form, a binary form, an encrypted form, and the like. Here, the storage media may include a personal portable storage device such as a smart card, a Universal Serial Bus (USB) token, and a cellular phone, a personal homepage such as a personal web blog and a cyworld homepage, an email, and the like.

The providing unit 250 restores the code value corresponding to the personalization code value with reference to the storage media, and provides the user with information in the tag using the restored code value. Alternatively, the providing unit 250 provides the user with the personalization code value and the code value with reference to the storage media.

The control unit 260 generally controls the RFID privacy protection apparatus 200 according to another exemplary embodiment of the present invention. The control unit 150 may control operations of the detection unit 210, the generation unit 220, the authentication unit 230, the storage unit 240, the providing unit 250 and the like.

The RFID privacy protection apparatus 200 may further include a display unit (not shown) to display an operation state, a setting state, and the like, and a receiving unit (not shown) to receive a command input from an external apparatus such as a keyboard and a touch screen, a password input, a verification command, a tag content verification, and the like.

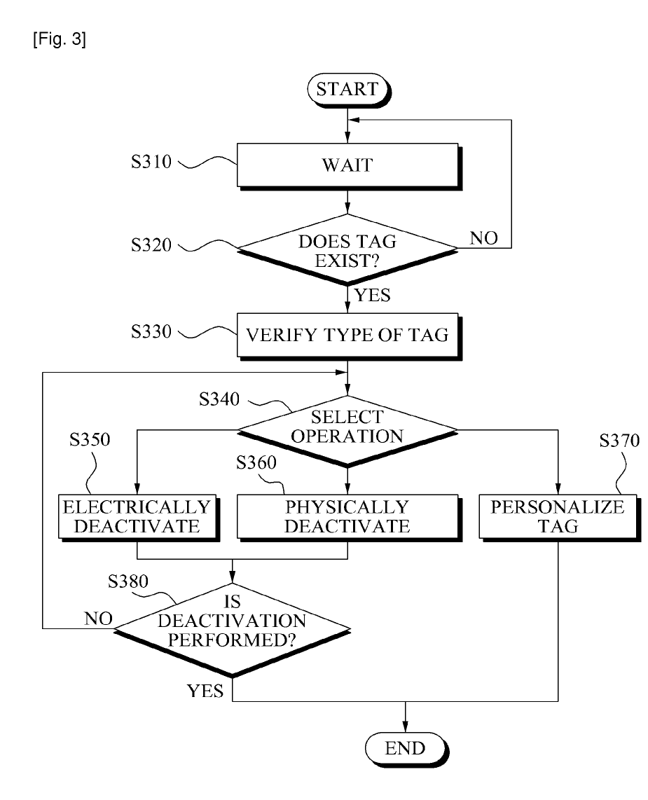

FIG. 3 is a flowchart briefly illustrating an RFID privacy protection method according to exemplary embodiments of the present invention. Here, the RFID privacy protection method according to exemplary embodiments of the present invention may be embodied by an RFID privacy protection apparatus.

Referring to FIG. 3, in operation S310, the RFID privacy protection apparatus waits. When a tag being an object of deactivation, tag personalization, tag value read, and the like exists, the RFID privacy protection apparatus proceeds to a subsequent operation state. In operation S320, the RFID privacy protection apparatus verifies whether the tag exists using an RFID reader. When it is verified that the tag does not exist, the RFID privacy protection apparatus performs operation S310.

In operation S330, when it is verified that the tag exists, the RFID privacy protection apparatus verifies a type of the tag. The RFID privacy protection apparatus may read either a code value of the tag or a specific user memory value, and verify the type of the tag by help of RFID middleware of the apparatus and a built-in database.

Depending on operation selection of a user in operation S340, the RFID privacy protection apparatus electrically deactivates the RFID tag of which the type is verified in operation S350, or physically deactivates the RFID tag in operation S360, or personalizes the RFID tag in operation S370. The RFID privacy protection apparatus may perform only a process of verifying the code value of the tag and verifying product information denoted by the code value, and may complete an operation. Which operation is performed may be determined by an apparatus operation of either an apparatus operator or individual consumers. The apparatus may operate in only a state set for a specific use.

After electrical deactivation in operation S350 is completed, the RFID privacy protection apparatus verifies whether the electrical deactivation is performed in operation S380. The RFID privacy protection apparatus passes through the same deactivation verification process in operation S380 when performing physical deactivation in operation S360. When the tag is not deactivated, the RFID privacy protection apparatus performs corresponding operations S350 and S5360 again, and a number of operation repetitions depends on a system setting value.

When the deactivation operation of the tag is completed, the RFID privacy protection apparatus may display, in a display unit, a message that the corresponding operation is successfully completed.

A tag personalization process in operation S370 denotes a process during which the code value of the legacy tag (or the user memory value) into a value known only by a tag owner. The RFID privacy protection apparatus may interoperate with a backend system, a personal cellular phone of the tag owner, a smart card, a web server, a blog, and the like, and securely store the tag value changed by the tag owner, an original value, and related information.

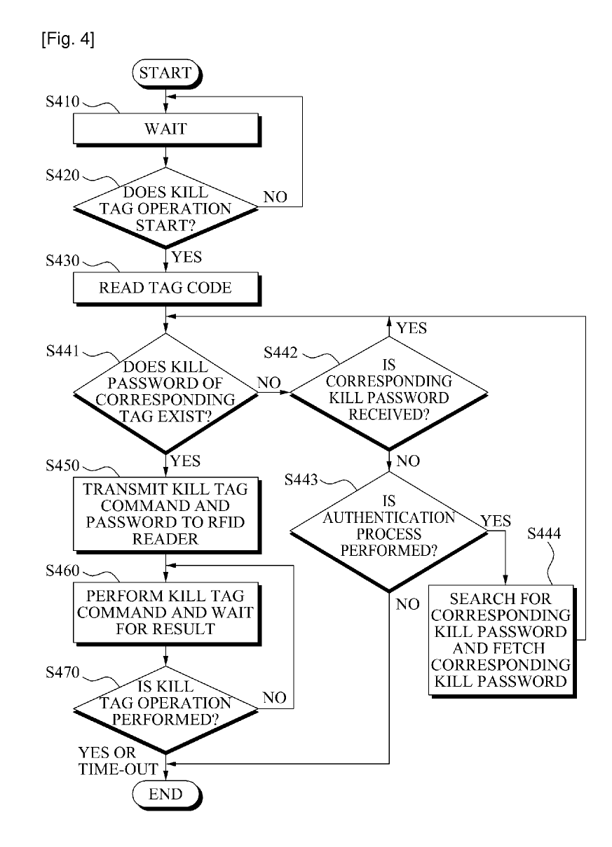

FIG. 4 is a flowchart illustrating an RFID privacy protection method according to an exemplary embodiment of the present invention.

Referring to FIG. 4, in operation S410, an RFID privacy protection apparatus waits. When the RFID privacy protection apparatus receives a kill tag command and a kill tag operation starts in operation S420, the RFID privacy protection apparatus performs a tag code verification process of reading a code value from a tag in operation S430.

The RFID privacy protection apparatus subsequently performs authentication concerning whether a kill password of a corresponding tag is accurately received, using the code value.

In operation S441, the RFID privacy protection apparatus verifies whether the kill password of the corresponding tag exists. When the corresponding kill password is received or was already received, this denotes that the kill password of the kill object tag exists. Accordingly, the RFID privacy protection apparatus proceeds to a subsequent operation S450 of transmitting the kill tag command and the password to an RFID reader.

Conversely, when the kill password of the corresponding tag does not exist, the RFID privacy protection apparatus receives the corresponding kill password in operation S442, or needs to bring a kill password value of the corresponding tag existing in an RFID backend server. In this instance, access needs to be performed only when a user owning the tag uses a reliable apparatus. For this, the RFID privacy protection apparatus performs an authentication process in operation S443.

A consumer needs to know the password of the corresponding tag in order to kill the tag attached to his/her own product. This may be known by reading either a Tag Identification (TID) value of the tag or the code value of the tag. The password to kill the tag may arbitrarily kill an RFID tag when an unauthorized person (or reader) acquires the tag, this may be a serious hacking attack. Accordingly, only an authorized person (or reader) needs to acquire the kill password. Therefore, the authentication process in operation S443 of verifying whether a corresponding apparatus includes an authority to access the kill password of the tag stored in a server is necessary.

When the authentication process in operation S443 is successfully performed, the RFID privacy protection apparatus searches for the corresponding kill password from the backend server passing through the authentication process and fetch the corresponding kill password in operation S444, and proceeds to a subsequent operation S450.

In operation S450, the RFID privacy protection apparatus transmits the kill tag command and the password to the RFID reader. In operation S460, while kill tag is performed in the RFID reader, the RFID privacy protection apparatus waits for a result.

In operation S470, when the tag succeeds in a kill tag operation, the RFID privacy protection apparatus ends the kill tag operation, and when the tag fails in the kill tag operation, the RFID privacy protection apparatus repeats the kill tag operation during predetermined times.

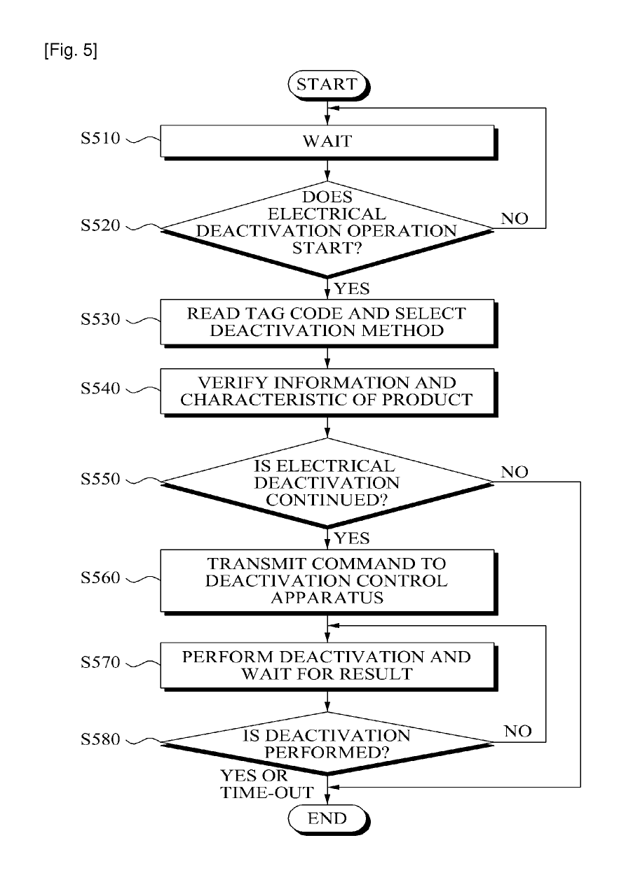

FIG. 5 is a flowchart illustrating an RFID privacy protection method according to another exemplary embodiment of the present invention.

An electrical tag deactivation method may be defined as a method of inducing a strong electric field and a magnetic field, and either burning a circuit of an RFID tag or erasing either an internal register or a memory, thereby making a normal tag operation to be difficult.

Referring to FIG. 5, in operation S510, an RFID privacy protection apparatus waits, and in operation S520, the RFID privacy protection apparatus starts an operation by an electrical deactivation start command. In operation S530, the RFID privacy protection apparatus automatically selects by which method electrical deactivation is performed based on a characteristic of the tag.

Since the RFID privacy protection apparatus may seriously damage a corresponding product when the electrical deactivation is performed in the case of the tag attached to home appliances, a computer hard disk, and a memory product, the RFID privacy protection apparatus verifies information and a characteristic of the product to which the tag is attached in operation S540, based on a tag code value read in operation S530, and determines whether the electrical deactivation is continued in operation S550. The RFID privacy protection apparatus performs the electrical deactivation with respect to only the tag attached to the product undamaged by the electrical deactivation.

In operation S560, the RFID privacy protection apparatus transmits a corresponding command to a deactivation control apparatus. In operation S570, when the deactivation is performed in the RFID tag, the RFID privacy protection apparatus waits for a result. In operation S580, the RFID privacy protection apparatus finally verifies whether the deactivation with respect to the tag is successfully performed. When the deactivation fails, the RFID privacy protection apparatus may repeat operations S550 through S580 during predetermined times.

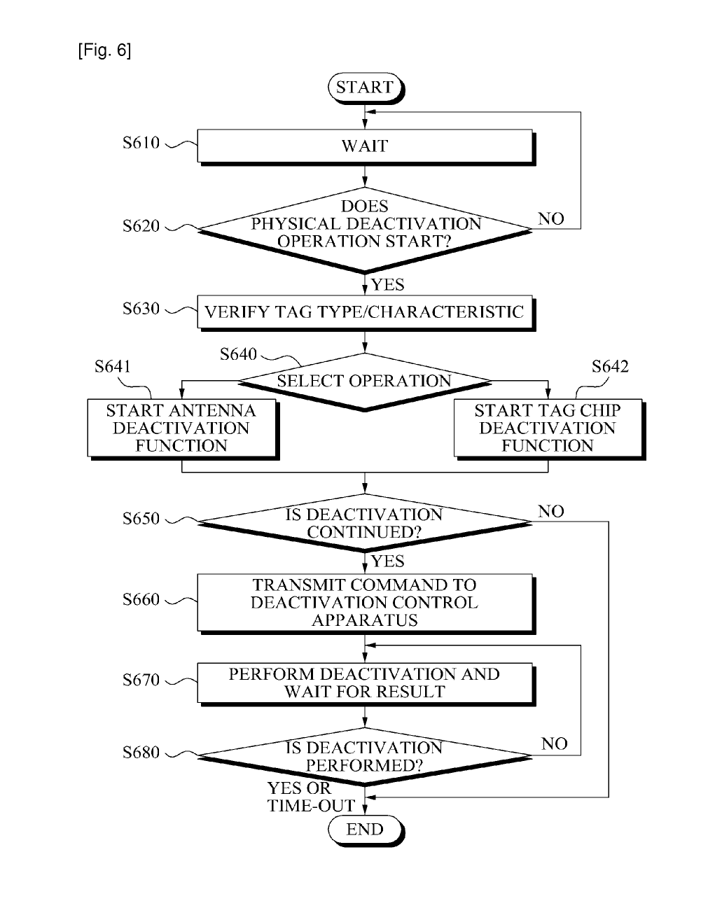

FIG. 6 is a flowchart illustrating an RFID privacy protection method according to still another exemplary embodiment of the present invention.

Referring to FIG. 6, an RFID privacy protection apparatus waits in operation S610, receives a command to start a physical deactivation operation in operation S620, verifies a type and a characteristic of a tag in operation S630, and selects a physical deactivation method in operation S640. The physical deactivation method includes a method of destroying an antenna and a method of physically pulverizing a tag chip.

When the method of destroying the antenna is selected as the physical deactivation method, the RFID privacy protection apparatus starts an antenna deactivation function in operation S641, and verifies whether deactivation is continued in operation S650 after reading a state of a control circuit to perform a corresponding function and verifying a state of the tag and the like.

Alternatively, when the method of physically pulverizing the tag chip is selected as the physical deactivation method, the RFID privacy protection apparatus starts a tag chip deactivation function in operation S642, and verifies whether the deactivation is continued in operation S650 after reading the state of the control circuit to perform the corresponding function and verifying the state of the tag and the like.

When it is verified that the deactivation is continued, the RFID privacy protection apparatus transmits a deactivation-related command to a deactivation control apparatus in operation S660, and when the deactivation is performed in an RFID tag, the RFID privacy protection apparatus waits for a deactivation result in operation S670.

In operation S680, the RFID privacy protection apparatus verifies whether the deactivation with respect to the tag is performed. When the deactivation of the tag is completed, the RFID privacy protection apparatus ends the present exemplary embodiment of the present invention. However, when the deactivation of the tag is not completed, the RFID privacy protection apparatus repeats operations S650 through S680 during predetermined times.

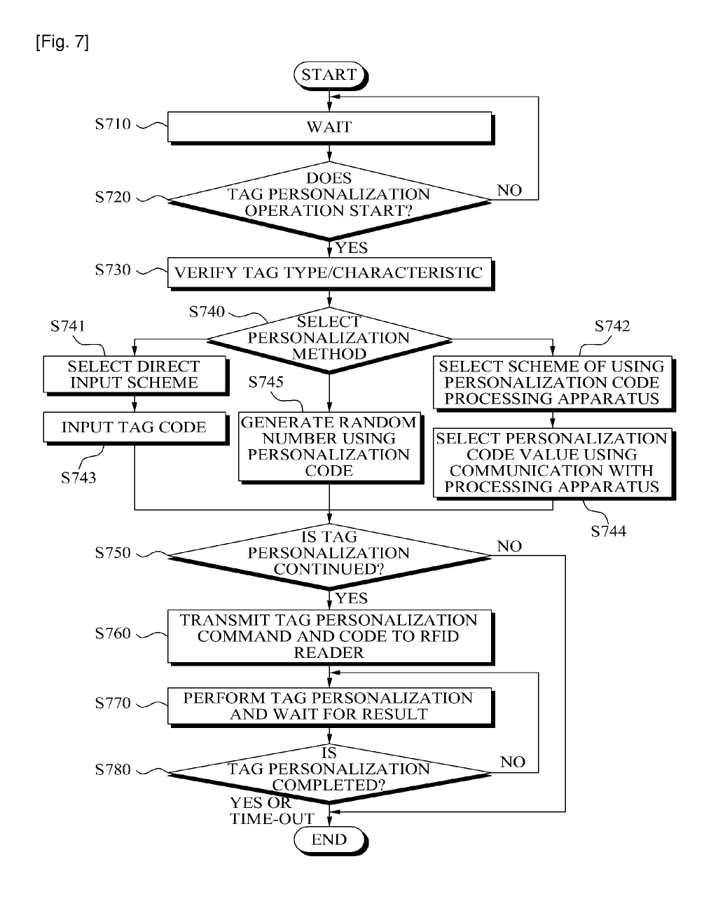

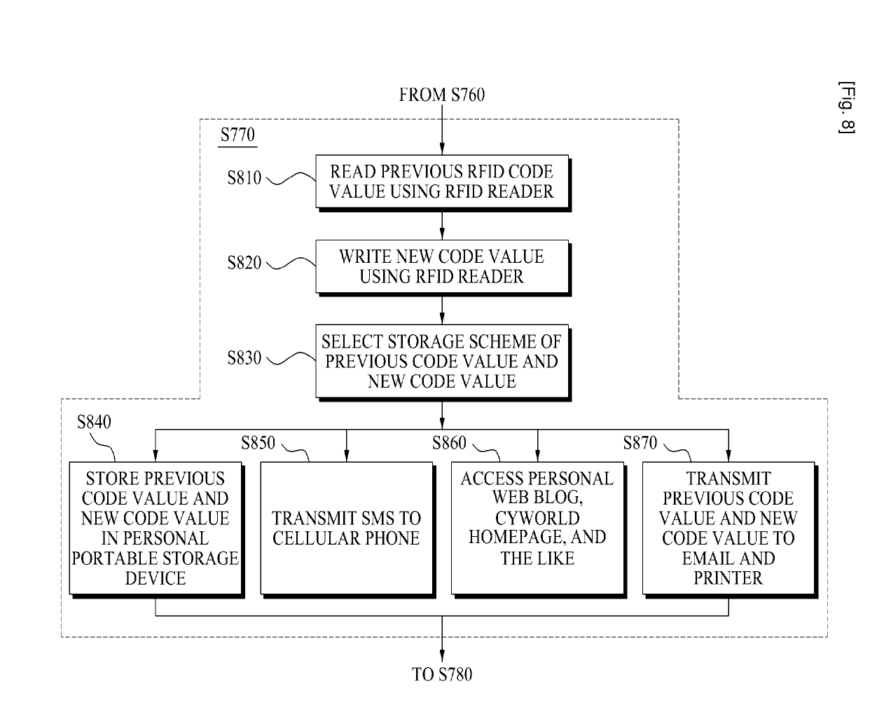

FIG. 7 is a flowchart illustrating an RFID privacy protection method according to yet another exemplary embodiment of the present invention.

Referring to FIG. 7, an RFID privacy protection apparatus maintains a wait state in operation S710 and when a tag personalization operation command is received, the RFID privacy protection apparatus starts a tag personalization operation in operation S720. When the tag personalization operation starts, the RFID privacy protection apparatus verifies a type and a characteristic of a tag in operation S730, and selects a tag personalization method based on the characteristic including a code standard of the corresponding tag, a user memory standard, and the like in operation S740.

The tag personalization method includes (1) a scheme of directly inputting a personalization code value, (2) a scheme of using a personalization code processing apparatus, and (3) a scheme of using a random number. When scheme (1) is selected in operation S741 based on the selecting in operation S740, the RFID privacy protection apparatus may directly receive a code value preferred by an individual consumer as a new code value (the personalization code value) from the individual consumer in operation S743.

Alternatively, when scheme (2) is selected in operation S742 based on the selecting in operation S740, the RFID privacy protection apparatus receives either the built-in personalization code value in the specially-manufactured personalization code processing apparatus such as a smart card, a USB token, and a cellular phone, or the personalization code value by a code generation rule in operation S744. The RFID privacy protection apparatus may store a previous code value and a personalized code value in a personal portable storage device such as the smart card, the USB token, the cellular phone, and the like.

Alternatively, when scheme (3) is selected in operation S740, the RFID privacy protection apparatus generates the random number using a random generator, and receives the generated random number as the personalization code value in operation S745.

As described above, after the tag personalization method is selected and a personalization code is generated, the RFID privacy protection apparatus inquires whether tag personalization is continued in operation S750. When the tag personalization is continued, the RFID privacy protection apparatus transmits a tag personalization command and a code to an RFID reader in operation S760, subsequently performs the tag personalization and waits for a tag personalization result in operation S770.

Hereinafter, operation S770 is described in detail.

FIG. 8 is a flowchart illustrating a process of performing tag personalization and waiting for a result according to an exemplary embodiment of the present invention.

Referring to FIG. 8, an RFID privacy protection apparatus reads a previous tag code value from a tag in operation S810, overwrites the read previous code value by a new code value (a personalization code value), and updates the previous code value in operation S820. In operation S830, the RFID privacy protection apparatus subsequently selects a storage scheme of the previous code value and the new code value (the personalization code value).

The storage scheme includes (1) a scheme of storing the previous code value and the new code value in a personal portable storage device in operation S840, (2) a scheme of transmitting a Short Message Service (SMS) to a cellular phone in operation S850, (3) a scheme of accessing a personal web blog, a cyworld homepage, and the like, and storing the previous code value and the new code value in operation S860, and (4) a scheme of transmitting the previous code value and the new code value to an email and a printer, and storing the previous code value and the new code value in operation S870.

When scheme (1) is selected in operation S830, the RFID privacy protection apparatus stores the previous code value and the updated code value (the personalization code value) in the personal portable storage device including a USB token, a smart card, and the like in any one of a text form, a binary form, and an encrypted form, restores the previous value with respect to the updated code value, and enables a desired RFID service to be provided in operation S840.

Alternatively, when scheme (2) is selected in operation S830, the RFID privacy protection apparatus transmits a pair of the previous code value and the new code value to the cellular phone carried by an individual consumer in a form of the SMS after selectively passing through an SMS authentication process with respect to the cellular phone, and enables a future service with respect to an RFID tag.

Alternatively, when scheme (3) is selected in operation S830, the RFID privacy protection apparatus accesses the personal web blog, the cyworld homepage, and the like, transmits and stores the code value of the previous RFID tag and the updated RFID code value (the personalization code value) in operation S860. This is possible since the present apparatus includes a wired/wireless communication apparatus and a structure of loading software.

The RFID privacy protection apparatus performs a process of authenticating an individual using a password and the like in order to transmit the previous code value and the new code value to a personal homepage and a blog and store the previous code value and the new code value. The RFID privacy protection apparatus enables an RFID code value pair (the previous code value and the updated code value) stored in the personal homepage and the like to be known anytime and anywhere and may easily provide RFID code value management and a related RFID service.

Alternatively, when scheme (4) is selected in operation S830, the RFID privacy protection apparatus transmits a corresponding code value pair (the previous code value and the updated code value) to a personal email or enables to the corresponding code value pair to be printed using the printer attached to an apparatus, thereby storing the corresponding code value pair in operation S870.

Referring to FIG. 7 again, the RFID privacy protection apparatus verifies whether the tag personalization is completed in operation S780. When it is verified that the tag personalization is not completed due to communication delay, an error, a temporary trouble of a device, and the like, the RFID privacy protection apparatus repeats operations S770 and S780 during predetermined times.

The exemplary embodiments of the present invention include computer-readable media including program instructions to implement various operations embodied by a computer. The media may also include, alone or in combination with the program instructions, local data files, local data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

According to the above-described exemplary embodiments of the present invention, it is possible to prevent a privacy intrusion problem resulting from RFID tag contents read by a random RFID reader regardless of consumers' own intentions, the consumers purchasing a product to which an RFID tag is attached.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. Therefore, it is intended that the scope of the invention be defined by the claims appended thereto and their equivalents.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A Radio Frequency Identification (RFID) privacy protection method, the method comprising:
receiving a password of a tag;
reading a code value from the tag;
performing authentication of a user with respect to the tag using the code value and the password; and
deactivating the tag electrically or physically based on a result of the performing.

2. The method of claim 1, wherein the deactivating comprises:
verifying a characteristic of the tag using the code value; and
deactivating the tag electrically or physically based on the verified characteristic of the tag.

3. The method of claim 1, wherein the deactivating comprises:
either
inducing either an electric field or a magnetic field, and burning a circuit of the tag; or
inducing either the electric field or the magnetic field, and erasing either a register or a memory in the tag.

4. The method of claim 3, wherein the deactivating comprises:
verifying a characteristic of a product to which the tag is attached, using the code value; and
electrically deactivating the tag based on the verified characteristic of the product.

5. The method of claim 1, wherein the deactivating comprises:
either
physically destroying an antenna in the tag; or
physically pulverizing a chip in the tag.

6. The method of claim 1, further comprising:
repeating a deactivation operation during predetermined times when the deactivation operation with respect to the tag fails.

7. An RFID privacy protection method, the method comprising:
detecting a code value from a tag;
changing the detected code value and generating a personalization code value; and
controlling access to the tag based on the generated personalization code value.

8. The method of claim 7, wherein the changing and generating comprises any one of:
receiving a second code value from a user, changing the code value into the received second code value, and generating the personalization code value;
generating the second code value using a random number generator, changing the code value into the generated second code value, and generating the personalization code value; and
generating the second code value using personal information of the user, the information existing in a mobile terminal of the user, changing the code value into the generated second code value, and generating the personalization code value.

9. The method of claim 7, further comprising:
storing the generated personalization code value in storage media related to a user of the tag.

10. The method of claim 9, wherein the storing comprises:
storing the personalization code value in the storage media, the personalization code value corresponding to the code value, and
further comprising:
restoring the code value corresponding to the personalization code value with reference to the storage media; and
providing the user with information in the tag using the restored code value.

11. The method of claim 10, further comprising:
providing the user with the personalization code value and the code value with reference to the storage media.

12. The method of claim 9, wherein the storing comprises:
storing the personalization code value and the code value in any one of a text form, a binary form, and an encrypted form.

13. An RFID privacy protection apparatus, the apparatus comprising:
a receiving unit to receive a password of a tag;
a reader unit to read a code value from the tag;
an authentication unit to perform authentication of a user with respect to the tag using the code value and the password; and
a deactivation unit to deactivate the tag electrically or physically based on a result of the performing.

14. The apparatus of claim 13, wherein the deactivation unit verifies a characteristic of the tag using the code value, and deactivates the tag electrically or physically based on the verified characteristic of the tag.

15. The apparatus of claim 13, wherein the deactivation unit induces either an electric field or a magnetic field and burns a circuit of the tag, or induces either the electric field or the magnetic field and erases either a register or a memory in the tag.

16. The apparatus of claim 13, wherein the deactivation unit verifies a characteristic of a product to which the tag is attached, using the code value, and electrically deactivates the tag based on the verified characteristic of the product.

17. The apparatus of claim 13, wherein the deactivation unit physically destroys an antenna in the tag, or physically pulverizes a chip in the tag.

18. The apparatus of claim 13, wherein the deactivation unit repeats a deactivation operation during predetermined times when the deactivation operation with respect to the tag fails.

19. An RFID privacy protection apparatus, the apparatus comprising:
a detection unit to detect a code value from a tag;
a generation unit to change the detected code value and to generate a personalization code value; and
an authentication unit to control access to the tag based on the generated personalization code value.

20. The apparatus of claim 19, wherein the generation unit receives a second code value from a user, changes the code value into the received second code value, and generates the personalization code value, or
generates the second code value using a random number generator, changes the code value into the generated second code value, and generates the personalization code value, or
generates the second code value using personal information of the user, the information existing in a mobile terminal of the user, changes the code value into the generated second code value, and generates the personalization code value.

21-24. (canceled)
